(19) United States
(12) Patent Application Publication
(10) Pub. No.: US 2003/0012508 A1
(43) Pub. Date: Jan. 16, 2003

(54) Fibre support

(75) Inventors: Paul Christopher Westmarland, Wiltshire (GB); Daniel Lee Wilmer, Oxon (GB); Matthew Peter Shaw, Oxford (GB)

Correspondence Address: SUGHRUE MION, PLLC, 2100 Pennsylvania Avenue, NW, Washington, DC, 20037-3213, US

(73) Assignee: BOOKHAM TECHNOLOGY, PLC.

(21) Appl. No.: 10/173,668

(22) Filed: Jun. 19, 2002

(30) Foreign Application Priority Data
Jun. 22, 2001 (GB) 0115368.3
Feb. 20, 2002 (GB) 0204005.3

(51) Int. Cl. G02B 6/30

(52) U.S. Cl. 385/49; 385/137

(57) ABSTRACT

A method for holding an end of at least one optic fibre in alignment for optical communication with an end of a respective optic element at a side edge of an optic chip; the method including the steps of: providing a fibre support supporting at least one optic fibre; assembling the fibre support and the optic chip so as to align the end of the at least one optic fibre with the end of the respective optic element at the side edge of the optic chip, wherein the fibre support includes a first portion that is configured to extend beyond the side edge over the optic chip when the end of the at least one optic fibre is aligned with the end of the respective optic element at the side edge; and then bonding said first portion of the fibre support to the optic chip to secure the fibre support to the optic chip.

### BACKGROUND OF THE INVENTION

The present invention relates to a fibre support for, and a method of, supporting an end of an optic fibre in optical alignment with an end of a respective element at a side edge of an optic chip, and to an optic system having an optic fibre supported in optical alignment with an end of a respective element at a side edge of an optic chip.

### FIELD OF THE INVENTION

An optic chip will typically comprise an underlying substrate supporting one or more overlying optic layers in which are defined one or more optic devices for generating an optic signal for transmission along an optic fibre, or processing or detecting an optic signal received from an optic fibre. The optic chip will typically include a waveguide terminating at a side edge of the optic chip for optical communication with an optic fibre. With reference to FIG. 9, a conventional method for holding the end of an optic fibre in optical alignment with the end of a waveguide at the side edge of a chip involves the use of a fibre block 2 for holding the end of the optic fibre 6 in optical alignment with a portion of the optic chip 8 defining the waveguide (not shown). The optic chip may, for example, be a silicon-on-insulator chip having an epitaxial silicon layer 14 formed on a silicon substrate 10 via a silicon oxide optical confinement layer 12. The side edge 16 of the optic chip including the end of the waveguide and the side edge 18 of the fibre block including the end of the optic fibre are polished to ensure a good fit between the side edges. As shown in FIG. 9, the side edge of the optic chip is polished at an angle, to provide for an angled (typically about 7°) connection between the end of the waveguide and the end of the optic fibre to reduce the risk of reflections interfering with the optic signal. The optic fibre block is secured to the optic chip via a layer of epoxy adhesive 19 between the side edges including between the end of the waveguide and the end of the optic fibre.

### SUMMARY OF THE INVENTION

It is an aim of the present invention to provide an alternative technique for holding the end of an optic fibre in optical alignment with an optic element at the side of an optic chip.

According to a first aspect of the present invention, there is provided a method for holding an end of at least one optic fibre in alignment for optical communication with an end of a respective optic element at a side edge of an optic chip; the method including the steps of: providing a fibre support supporting at least one optic fibre; assembling the fibre support and the optic chip so as to align the end of the at least one optic fibre with the end of the respective optic element at the side edge of the optic chip, wherein the fibre support includes a first portion that is configured to extend beyond the side edge over the optic chip when the end of the at least one optic fibre is aligned with the end of the respective optic element at the side edge; and then bonding said first portion of the fibre support to the optic chip to secure the fibre support to the optic chip.

According to another aspect of the present invention, there is provided a fibre support for supporting an end of at least one optic fibre in alignment for optical communication with an end of a respective optic element at a side edge of an optic chip, the fibre support including a first portion that is configured to extend beyond the side edge over the optic chip when the end of the optic fibre is aligned for optical communication with said end of the respective optic element so as to provide a location for bonding the fibre support to the optic chip that is remote from said ends of the at least one optic fibre.

According to another aspect of the present invention, there is provided a fibre support for supporting an end of each one of an array of optic fibres in alignment for optical communication with an end of a respective one of an array of optic elements at a side edge of an optic chip, the fibre support including a first portion that is configured to extend beyond the side edge over the optic chip when the ends of the optic fibres are aligned for optical communication with the ends of the optic elements so as to provide a location for bonding the fibre support to the optic chip that is remote from said ends of the optic fibres.

According to another aspect of the present invention, there is provided an optic system including an optic chip having an end of at least one optic element at a side edge thereof, and an optic fibre support supporting an end of at least one optic fibre in alignment for optical communication with said end of said at least one optic element, wherein the optic fibre support is secured to the optic chip by a bond between the optic chip and a first portion of the fibre support that extends beyond the side edge over the optic chip.

According to another aspect of the present invention, there is provided an optic system including an optic chip having an array of optic elements ending at a side edge thereof, and an optic fibre support supporting an array of optic fibres in alignment for optical communication with the ends of the optic elements, wherein the optic fibre support is secured to the optic chip by a bond between the optic chip and a first portion of the fibre support that extends beyond the side edge over the optic chip.

Embodiments of the present invention are described hereunder, by way of example only, with reference to the accompanying drawings. The embodiments described hereunder are not intended to be limiting, and the scope of the present invention is to be understood as covering those variations covered by the scope of the claims.

### BRIEF DESCRIPTION OF THE DRAWINGS

FIG. 1 is a perspective view of a fibre support attached to an optic chip according to a first embodiment of the present invention;

FIG. 2 is a vertical cross-sectional view taken through the axis of one of the optic fibres of the system shown in FIG. 1;

FIG. 3 is a vertical cross-sectional view taken through line A-A in FIG. 1;

FIG. 4 is a perspective view of a fibre support attached to an optic chip according to a first embodiment of the present invention;

FIG. 5 is a vertical cross-sectional view taken along the axis of one of the optic fibres in the system shown in FIG. 4 with a lid fitted over the window;

FIG. 6 illustrates how the side edge of the optic chip in FIG. 5 is prepared prior to attachment to the fibre support;

FIG. 7 shows a fibre support and an optic chip according to another embodiment in an unassembled state and in the assembled state;

FIG. 8 is a vertical cross-sectional view of the back end of a variation of the lower fibre block used in the system shown in FIG. 4;

FIG. 9 shows a prior art method for aligning the end of an optic fibre with an optic element at the side edge of an optic chip; and

FIG. 10 is a cross-sectional view of mating elements for facilitating assembly of the fibre support and optic chip in an aligned state according to an embodiment of the present invention

### DESCRIPTION OF THE PREFERRED EMBODIMENT

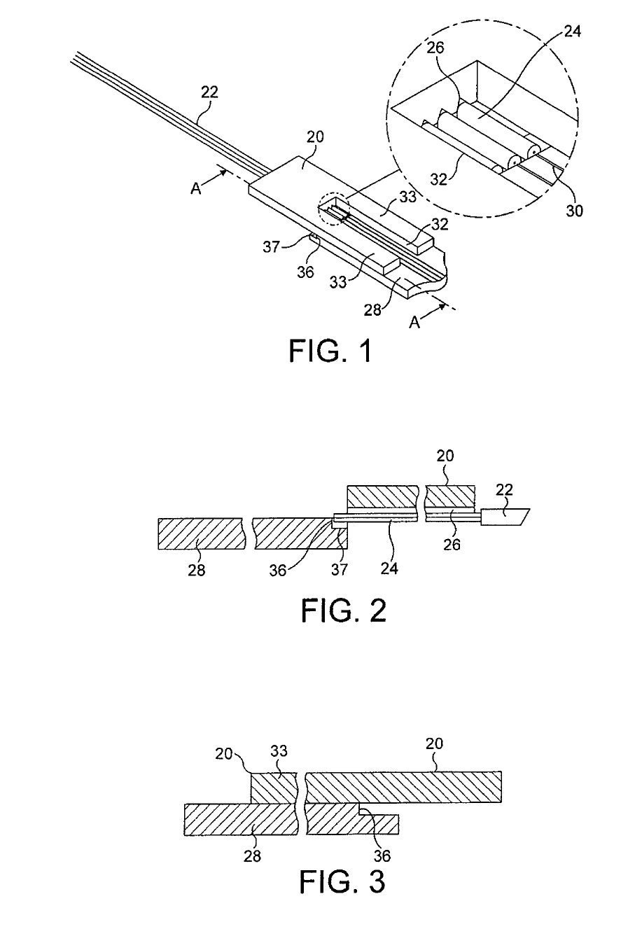

With reference to FIG. 1, a length of the plurality of longitudinal optic fibres 24 of a fibre ribbon 22 are unsheathed and are held by epoxy adhesive in an array of parallel V-grooves 26 formed on the undersurface of a planar silicon block 20, hereinafter referred to as the silicon V-block. The silicon V-block includes an etched slot 32 through which a 1 mm length at the end of each of the unsheathed optic fibres 24 is exposed whilst leaving a pair of arms 33 of the block that extend longitudinally beyond the ends of the optic fibres. The slot helps to reduce the risk of any damage to the ends of the waveguides in the assembly process and also facilitates a first “light” stage of the optical alignment process. The final, accurate alignment of the ends of the optic fibres with the ends of the waveguides at the side edge of the optic chip may be carried out by a standard active process with about a 5 micron gap between the end of each waveguide and the respective optic fibre end. Once the alignment process is complete, the silicon V-block is secured to the optic chip by curing a layer of epoxy adhesive provided between the planar undersurface of the arms 33 and the corresponding planar portion of the top surface of the optic chip. The arms 33, which are a monolithically integral part of the silicon block, extend by about 5 mm beyond the side edge over the optic chip.

There is no need for any epoxy adhesive in the optical path between the ends of the optic fibres and the ends of the waveguides for the purpose of securing the silicon V-block to the optic chip, as is required in the conventional technique, for which there are fears that a reduction in optical power will arise over a period of time as a result of degradation and discolouring of the epoxy in the optical path. However, the present invention does not exclude the additional use of epoxy between the ends of the fibres and the waveguides. For example, an epoxy of index matching gel may be used if required. In this case, the epoxy can be optimised for its optical function since the bond between the arms of the silicon block and the upper surface of the optic chip provides by itself the degree of mechanical strength required for the connection between the silicon block and the optic chip. An epoxy connection between the ends of the fibres and the waveguides may provide some mechanical strength, but this secondary to the primary source of mechanical strength provided by the bond between the arms of the silicon block and the upper surface of the optic chip.

The above-described technique allows for a relatively rugged interface. It can also provide a chip/block assembly having a relatively low profile because the ribbon fibre and the optic chip can be parallelly arranged, which in turn enables the design of a relatively flat package.

In this example, the optic chip 28 is a silicon-on-insulator chip, with the waveguides defined by ribs etched into the epitaxial silicon layer. In the system shown in FIG. 1, the optic chip is prepared in advance by dry etching a vertical facet into the side edge at which the waveguides terminate. This can be carried out at “wafer-scale” during the process of etching to define the basic optic elements such as the rib waveguides 30 before the wafer is diced into a plurality of optic chips. The step of forming the vertically etched facet 36 leaves a step 37 approximately 200 microns below the top surface of the chip, over which the exposed end lengths of the fibres extend in the assembled product. The vertical etched facet defining the ends of the waveguides is coated with a nitride anti-reflection coating (not shown). This preparation of the side edge has an advantage over the conventional polishing process of involving considerably less chance of damage to the chip.

On the optic fibre side, the end of each optic fibre is cleaved, preferably at an angle (i.e. other than 90°) to the axis of the optic fibre. This can be achieved using a laser and renders the end of each optic fibre in a suitable condition for presentation to the vertically etched facet 36 defining the ends of the waveguides. The laser cleaving may be carried out after attaching the fibres to the silicon V-block. The V-block acts as an accurate silicon jigging tool ensuring that the fibres are presented in the correct position for the cleaving process. Furthermore, the fibres are also partially protected by the V-block once the cleaving operation is completed, making both handling and storage safer.

If the slot in the silicon V-block is formed in a precise relationship to the optic fibres (as can be achieved in an accurate wafer fabrication process), the process of alignment can be facilitated by adding fiducial alignment marks to the top of the optic chip, which when aligned with the edge of the silicon V-block defining the slot indicate at least a light level of alignment of the ends of the optic fibres with the waveguide ends. The provision of such fiducial marks may also allow accurate alignment to be carried out passively without the need for a subsequent active alignment step. Alternatively, light alignment could, for example, be carried out by connection of a visible HeNe laser.

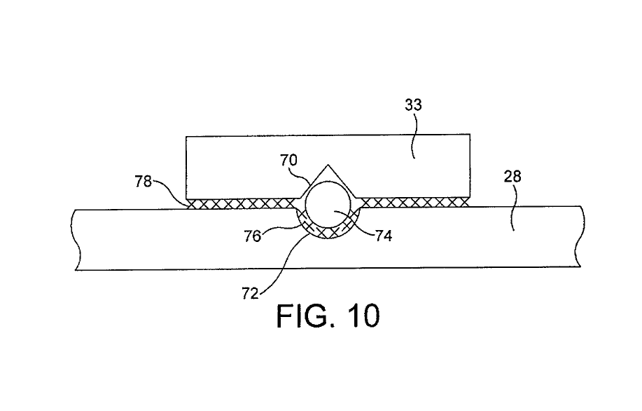

According to one variation, alignment can be facilitated by the provision of complementary mating elements on the upper surface of the optic chip and the undersurface of the arms. For example, such mating elements could be provided as shown in FIG. 10. A V-groove 70 is etched into the undersurface of each arm of the silicon block for receiving a cylindrical element 74 (such as a small length of optic fibre) secured by adhesive 76 in a U-groove 72 etched into the upper surface of the optic chip by dry etching. The V-shaped grooves 70 and complementary cylindrical elements 74 facilitate alignment whilst the surrounding planar portions of the undersurface of the arms and the upper surface of the optic chip provide for a strong adhesive bond 78 between the silicon block and the optic chip. The use of U-grooves 72 is advantageous in that their orientation is not limited by the orientation of the crystal planes.

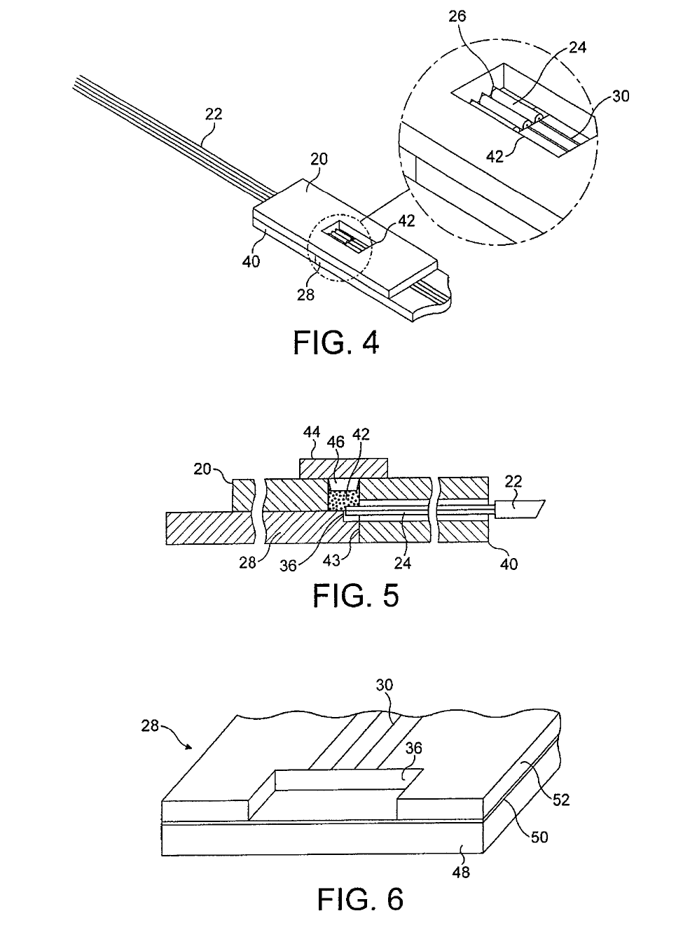

In one variation, the silicon V-block may also be used in combination with a matching lower V-block to enhance good fibre positioning in the V-grooves 26. In another variation, the slot may be replaced by a window. A system including a silicon V-block incorporating a window and a lower V-block is shown in FIGS. 4 and 5.

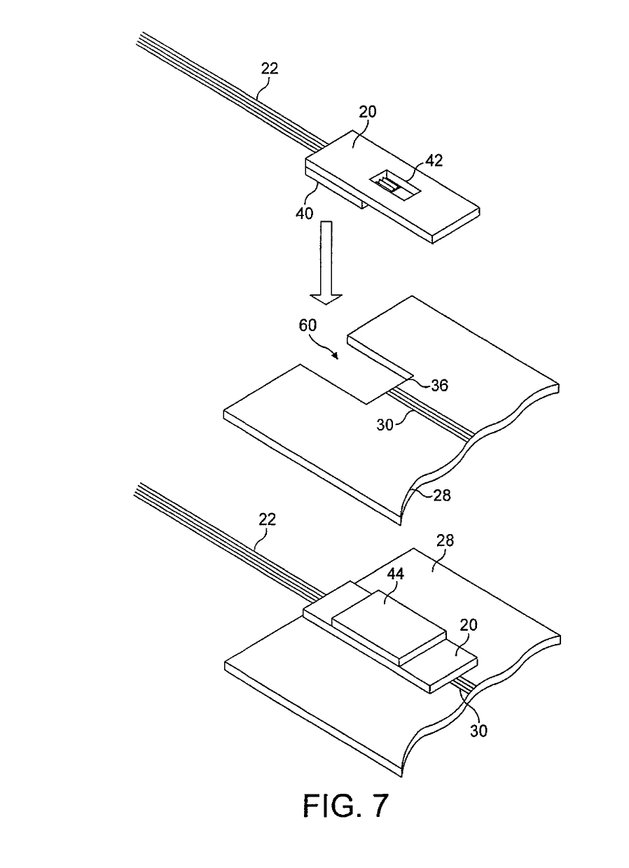

The system shown in FIGS. 4 to 6 differs from the system shown in FIGS. 1 to 3 in the following respects. Firstly, the silicon V-block 20 is provided with a window 42 rather than a slot for exposing an end length of each of the optic fibres 24. Secondly, a lower V-block 40 is provided with the optic fibres sandwiched for support between matching V-grooves on the mating surfaces of the two V-blocks. The preparation of the side edge of the optic chip is also somewhat different as shown in FIG. 6. The etched facet section 36 is reduced in width to give enclosing walls on the edge of the optic chip after dicing of the wafer. The side edge of the optic chip and the fibre support including the upper and lower silicon V-blocks are thus adapted such that when assembled in an optically aligned condition the front face of the lower silicon V-block abuts with a portion of the side edge of the optic chip, such that when the window is closed off after alignment using a silicon lid 44 provided with a locating protrusion 46 on its undersurface the ends of the optic fibres and the ends of the waveguides are isolated in a silicon “box”. The floor and sides of the box are defined by the dry etched facet 36, the front faces of the lower V-block 40 and the etched walls of the window 42 in the upper silicon V-block 20. This allows the ends of the optic fibres and the waveguides to be protected and shielded without the need for epoxy in the gap between the ends of the waveguides and the optic fibres. This has an advantage in a non-hermetic packaging application (pre-moulded application), in that it provides protection against dust or mould particles.

In another embodiment shown in FIG. 7, there is also employed a fibre support of the type shown in FIGS. 4 and 5 including upper and lower silicon V-blocks 20, 40 with a window 42 provided in the upper silicon V-block 20. However, in this embodiment, the optic chip is provided with a recess 60 that extends right through the optic chip including the underlying silicon substrate such that upon assembly of the fibre support and the optic chip in an aligned condition, the rear face of the fibre support is continuous with a side edge of the optic chip. This reduces the package footprint of the product. As in the embodiment shown in FIGS. 4 and 5, the window is closed with a lid after securing the fibre support to the optic chip in an optically aligned condition to protect the cleaved ends of the optic fibre from contamination. Also as in the embodiment shown in FIGS. 4 and 5, registration of the lid to the top of the upper silicon V-block is facilitated by etching a protrusion 46 to fit into the window in the upper silicon V-block.

The recess 60 can be formed by etching in wafer fabrication, but should be wide enough to account for variation in the dicing width of the V-block and for the roll alignment and search algorithms the alignment equipment may need to perform.

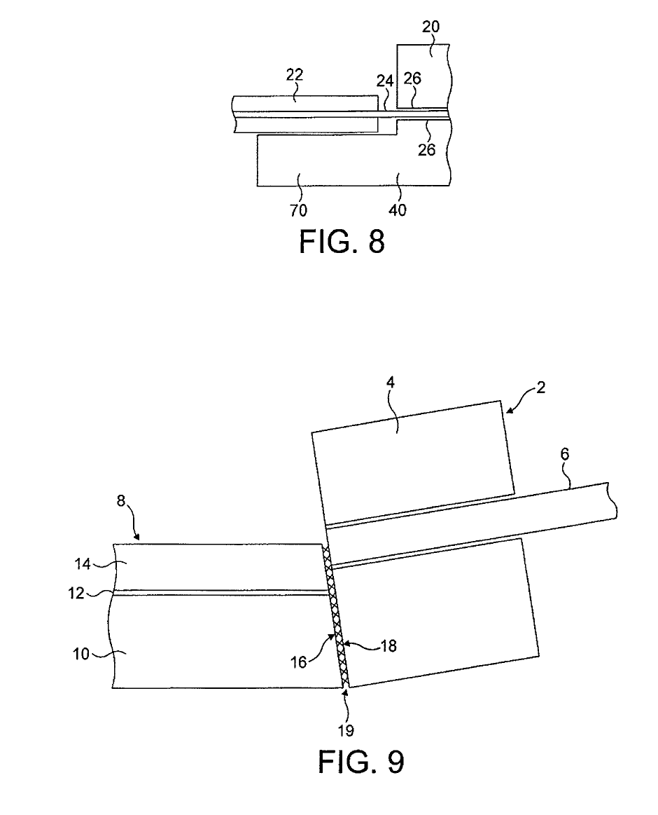

As shown in FIG. 8, the lower V-block used in the embodiments shown in FIGS. 4 to 7 may be modified to include an extension 70 protruding longitudinally beyond the rear end of the upper silicon block to support the fibre ribbon and reduce the stress on the fibres at the point where they enter the V-grooves on the upper and lower silicon V-blocks.

The variations discussed for the embodiment shown in FIGS. 1 to 3 are also applicable to the embodiments shown in FIGS. 4 to 7.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A method for holding an end of at least one optic fibre in alignment for optical communication with an end of a respective optic element at a side edge of an optic chip; the method including the steps of: providing a fibre support supporting at least one optic fibre; assembling the fibre support and the optic chip so as to align the end of the at least one optic fibre with the end of the respective optic element at the side edge of the optic chip, wherein the fibre support includes a first portion that is configured to extend beyond the side edge over the optic chip when the end of the at least one optic fibre is aligned with the end of the respective optic element at the side edge; and then bonding said first portion of the fibre support to the optic chip to secure the fibre support to the optic chip.

2. A method according to claim 1, wherein the fibre support is shaped to expose an end length of the at least one optic fibre to facilitate alignment of said end of the least one optic fibre with said end of the respective optic element.

3. A method according to claim 1 or claim 2 wherein at least part of the first portion of the fibre support has a planar surface for bonding to a planar surface portion of the optic chip.

4. A method according to claim 3, wherein another part of the first portion and another portion of the optic chip are provided with corresponding mating elements to facilitate connection of the fibre support and the optic chip in an aligned state.

5. A method according to claim 1, wherein the optic chip includes alignment marks for assisting the step of assembling the fibre support and the optic chip into an aligned state.

6. A method according to claim 1 wherein the optic chip and the fibre support are assembled together so as to encapsulate said end of the at least one optic fibre and the respective optic element.

7. A method according to claim 1 wherein the fibre support defines a window that exposes an end length of the at least one optic fibre to facilitate alignment of said end of the at least one optic fibre with said end of the respective optic element.

8. A method according to claim 5 wherein the optic chip and fibre support are assembled together such that said end of the at least one optic fibre and the respective optic element is encapsulated other than via the window, and including the further step of blocking the window so as to complete the encapsulation.

9. A method according to claim 1, wherein the end of the at least one optic element is defined by an etched facet.

10. A method according to claim 1, wherein the optic element is a waveguide.

11. A method according to claim 1 wherein the optic chip is a silicon-on-insulator chip.

12. A method according to claim 1 including the step of laser cleaving the ends of the fibres.

13. A fibre support for supporting an end of at least one optic fibre in alignment for optical communication with an end of a respective optic element at a side edge of an optic chip, the fibre support including a first portion that is configured to extend beyond the side edge over the optic chip when the end of the optic fibre is aligned for optical communication with said end of the respective optic element so as to provide a location for bonding the fibre support to the optic chip that is remote from said ends of the at least one optic fibre.

14. A fibre support according to claim 13 wherein the fibre support is shaped to expose an end length of the at least one optic fibre to facilitate optical alignment of said end of the at least one optic fibre.

15. A fibre support according to claim 13 wherein the fibre support defines a window that exposes an end length of the at least one optic fibre to facilitate optical alignment of said end of the at least one optic fibre.

16. A fibre support according to any of claims 13 to 15 including two components bonded together and between which the at least one optic fibre is securely supported.

17. A fibre support according to claim 16 wherein the two components include matching V-grooves supporting the at least one optic fibre.

18. A fibre support according to claim 13 wherein at least part of the first portion has a planar surface for bonding to a planar surface portion of an optic chip.

19. A fibre support according to claim 18, wherein another part of the first portion is provided with a mating element to facilitate connection to the optic chip in an aligned state.

20. A fibre support for supporting an end of each one of an array of optic fibres in alignment for optical communication with an end of a respective one of an array of optic elements at a side edge of an optic chip, the fibre support including a first portion that is configured to extend beyond the side edge over the optic chip when the ends of the optic fibres are aligned for optical communication with the ends of the optic elements so as to provide a location for bonding the fibre support to the optic chip that is remote from said ends of the optic fibres.

21. An optic system including an optic chip having an end of at least one optic element at a side edge thereof, and an optic fibre support supporting an end of at least one optic fibre in alignment for optical communication with said end of said at least one optic element, wherein the optic fibre support is secured to the optic chip by a bond between the optic chip and a first portion of the fibre support that extends beyond the side edge over the optic chip.

22. An optic system including an optic chip having an array of optic elements ending at a side edge thereof, and an optic fibre support supporting an array of optic fibres in alignment for optical communication with the ends of the optic elements, wherein the optic fibre support is secured to the optic chip by a bond between the optic chip and a first portion of the fibre support that extends beyond the side edge over the optic chip.

23. An optic system according to claim 21 or 22 wherein at least part of the first portion of the fibre support has a planar surface for bonding to a planar surface portion of the optic chip.

24. An optic system according to claim 23, wherein another part of the first portion and another portion of the optic chip are provided with corresponding mating elements to facilitate connection of the fibre support and the optic chip in an aligned state.
